(19) United States
(12) Patent Application Publication
(10) Pub. No.: US 2025/0128338 A1
(43) Pub. Date: Apr. 24, 2025

(54) Flexible Drill Bit and Kit

(71) Applicant: Milwaukee Electric Tool Corporation, Brookfield, WI (US)

(72) Inventors: John J. Springer, Milwaukee, WI (US); Carter Gibson, New Berlin, WI (US); Jake J. Konieczka, Wauwatosa, WI (US)

(21) Appl. No.: 18/830,289

(22) Filed: Sep. 10, 2024

Related U.S. Application Data
(60) Provisional application No. 63/592,391, filed on Oct. 23, 2023.
(60) Provisional application No. 63/610,705, filed on Dec. 15, 2023.

(51) Int. Cl. B23B 51/00

(52) U.S. Cl. CPC B23B 51/00; B23B 2260/068

(57) ABSTRACT

Various embodiments of a flexible drill bit assembly are provided. The flexible drill bit assembly includes structures that allow users to position and direct the flexible drill bit assembly during use and easily interchange components on the ends of the flexible drill bit shaft without requiring additional fasteners, and the flexible drill bit assembly optionally includes a sleave that slides along a flexible shaft of the flexible drill bit assembly.

### CROSS REFERENCE TO RELATED PATENT APPLICATIONS

The present application claims the benefit of and priority to U.S. Provisional Application No. 63/610,705 filed on Dec. 15, 2023, and U.S. Provisional Application No. 63/592,391 filed on Oct. 23, 2023, each of which is incorporated herein by reference in its entirety.

### BACKGROUND OF THE INVENTION

The present invention relates generally to the field of tool accessories. The present invention relates specifically to a flexible drill bit.

### SUMMARY OF THE INVENTION

Various embodiments of the invention relate to a flexible drill bit assembly configured to allow users to position and direct the flexible drill bit assembly during use and easily interchange components on the ends of a flexible drill bit shaft without requiring additional fasteners. The flexible drill bit assembly includes a collar around the flexible drill bit shaft that freely rotates with respect to the flexible drill bit shaft such that forces can be applied to the collar by the user to move, bend, flex, position, etc. the flexible drill bit assembly while in use.

One embodiment of the invention relates to a flexible drill bit assembly for a power drill including a flexible shaft extending from a first end to an opposing second end, a driving tool engaging shank coupled to the first end of the flexible shaft, a tool head receiver coupled to the second end of the flexible shaft, and a collar defining an interior channel through which the flexible shaft extends. The driving tool engaging shank is configured to detachably couple to a power drill. The tool head receiver is configured to detachably couple to a tool head. The collar is axially slidable along the flexible shaft, and the collar is rotatable with respect to the flexible shaft.

Another embodiment of the invention relates to a flexible drill bit assembly for a power drill including a flexible shaft extending from a first end to an opposing second end, a driving tool engaging shank detachably coupled to the first end of the flexible shaft, and a tool head receiver coupled to the second end of the flexible shaft. The driving tool engaging shank is configured to detachably couple to a power drill. The tool head receiver is configured to detachably couple to a tool head.

Another embodiment of the invention relates to a flexible drill bit assembly for a power drill including a flexible shaft extending from a first end to an opposing second end, a driving tool engaging shank coupled to the first end of the flexible shaft, and a tool head receiver detachably coupled to the second end of the flexible shaft. The driving tool engaging shank is configured to detachably couple to a power drill. The tool head receiver is configured to detachably couple to a tool head.

Another embodiment of the invention relates to a flexible drill bit assembly including a flexible shaft, a hex shank attachment, and a hex receiver attachment. The hex shank attachment and hex receiver attachment are coupled to the flexible shaft on opposing ends of the flexible shaft. The hex shank attachment is configured to couple the flexible shaft to a driving tool, such as a power drill, or to an additional flexible shaft without requiring additional fasteners. The hex receiver attachment is configured to couple the flexible shaft to tool head, such as a drill bit accessory, a hook accessory, a through-hole bullet nose accessory, a finger trap wire accessory, a tile cutter, a collar, a dirt auger, a wood auger, etc., or an additional flexible shaft without requiring additional fasteners.

Another embodiment of the invention relates to a flexible drill bit assembly kit. The flexible drill bit assembly kit includes a flexible drill bit shaft having a hex shank attachment coupled to a first end and a hex receiver attachment coupled on a second end. The flexible drill bit assembly kit further includes a hook accessory, a through-hole bullet nose accessory, a finger trap wire accessory, a tile cutter, a collar, a dirt auger, a first, second, third, and fourth wood auger, a first alignment ball, a second alignment ball, and an alignment cage.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1A is a perspective view of a flexible drill bit assembly, according to an exemplary embodiment.

FIG. 1B is a perspective view of a flexible drill bit assembly in a bent position, according to an exemplary embodiment.

FIG. 2A is a side view of a flexible drill bit assembly, according to an exemplary embodiment.

FIG. 2B is a side view of a flexible drill bit assembly, according to an exemplary embodiment.

FIG. 2C is a side view of a flexible drill bit assembly, according to an exemplary embodiment.

FIG. 3 is a perspective view of a drill bit collar of the flexible drill bit assembly of FIG. 1A, according to an exemplary embodiment.

FIG. 4 is a side view of the drill bit collar of FIG. 3, according to an exemplary embodiment.

FIG. 5 is a cross-sectional side view of the drill bit collar of FIG. 3, according to an exemplary embodiment.

FIG. 6 is a perspective view of a hex shank attachment of the flexible drill bit assembly of FIG. 1A, according to an exemplary embodiment.

FIG. 7 is a side view of the hex shank attachment of FIG. 6, according to an exemplary embodiment.

FIG. 8 is a side perspective view of the hex shank attachment of FIG. 6, according to an exemplary embodiment.

FIG. 9 is cross-sectional side view of the hex shank attachment of FIG. 6, according to an exemplary embodiment.

FIG. 10 is a perspective view of a hex receiver attachment of the flexible drill bit assembly of FIG. 1A, according to an exemplary embodiment.

FIG. 11 is a side perspective view of the hex receiver attachment of FIG. 10, according to an exemplary embodiment.

FIG. 12 is a side perspective view of the hex receiver attachment of FIG. 10, according to an exemplary embodiment.

FIG. 13 is a cross-sectional side view of the hex receiver attachment of FIG. 10, according to an exemplary embodiment.

FIG. 14 is a perspective view of a square drive attachment, according to an exemplary embodiment.

FIG. 15 is a side view of the square drive attachment of FIG. 14, according to an exemplary embodiment.

FIG. 16 is a side perspective view of the square drive attachment of FIG. 14, according to an exemplary embodiment.

FIG. 17 is a cross-sectional side view of the square drive attachment of FIG. 14, according to an exemplary embodiment.

FIG. 18 is a detailed view of a drill bit shaft, a hex receiver attachment, and an auger attachment of the flexible drill bit assembly of FIG. 1A, according to an exemplary embodiment.

FIG. 19 is a detailed view of a drill bit shaft and a hex shank attachment of the flexible drill bit assembly of FIG. 1A, according to an exemplary embodiment.

FIG. 20 is a side view of various tool heads of a flexible drill bit kit, according to an exemplary embodiment.

FIG. 21 is a perspective view of a hook accessory attachment, according to an exemplary embodiment.

FIG. 22 is a perspective view of a through-hole bullet nose accessory attachment, according to an exemplary embodiment.

FIG. 23 is a perspective view of a finger trap wire accessory attachment, according to an exemplary embodiment.

FIG. 24 is a perspective view of an alignment ball accessory, according to an exemplary embodiment.

FIG. 25A is a side view of a flexible drill bit shaft, according to an exemplary embodiment.

FIG. 25B is a side view of a flexible drill bit shaft, according to an exemplary embodiment.

FIG. 25C is a side view of a flexible drill bit shaft, according to an exemplary embodiment.

FIG. 25D is a side view of a flexible drill bit shaft, according to an exemplary embodiment.

FIG. 26 is a side view of a tool case, according to an exemplary embodiment.

### DETAILED DESCRIPTION

Referring generally to the figures, various embodiments of a flexible drill bit assembly having a collar are shown. Flexible drill bits may be for a variety of drilling tasks, such as for creating holes within residential or commercial buildings for the purpose of running wiring or cabling through walls. In some conventional flexible drill bit assemblies, users may have difficulties in accurately positioning the end of the flexible drill bit and determining whether the flexible drill bit is placed in the desired location. Applicant has found that these inaccuracies can result in drilling holes in undesired locations and/or directions, which may cause damage to walls, ceilings, or floorings.

In contrast, the flexible drill bit assemblies discussed herein utilize a collar around the flexible drill bit that freely rotates with respect to the flexible drill bit. The collar of the flexible drill bit assembly is used as a positioning/bending handle that the user grips to apply a bending force to the shaft of the flexible drill bit to angle/position the driving tip of the flexible drill bit. The flexible drill bit assemblies provide various advantages over typical flexible drill bit assemblies, including allowing users to direct and position the flexible drill bit during use by hand by gripping the collar. Further, in contrast to flexible drill bit assemblies that utilize a separate bending tool to bend the drill bit shaft, the flexible drill bit assemblies discussed herein allow users to receive relatively strong haptic signals through the collar when the flexible drill bit contacts an object, due to the short distance between the user's hand and the flexible drill bit when holding the collar. The close contact of the collar to the flexible drill bit shaft is also believed to allow the user to better feel the degree of bending or the bending angle of the drill bit shaft.

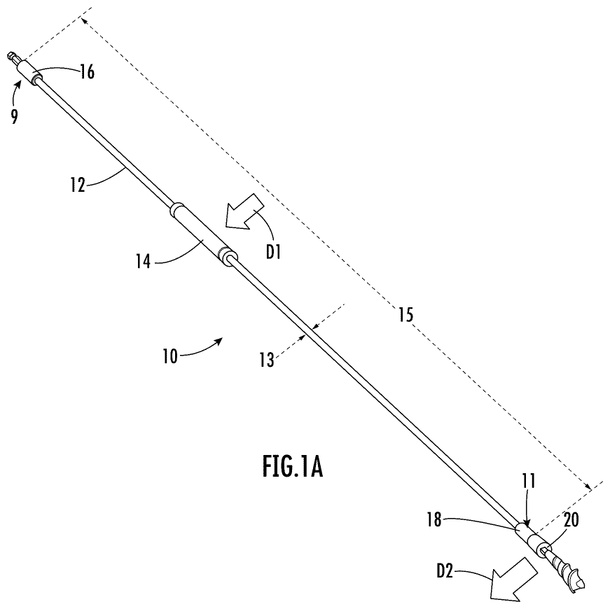

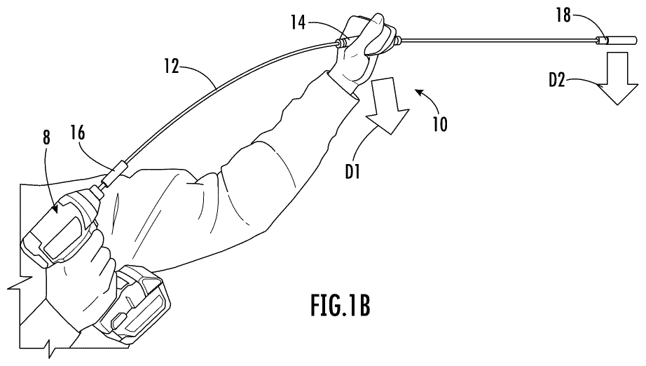

Referring to FIGS. 1A-1B, a flexible drill bit assembly 10 for power drill 8 is shown according to an exemplary embodiment. As illustrated, flexible drill bit assembly 10 includes a flexible shaft 12, a positioning handle, shown as a collar 14, a driving tool engaging shank, shown as a hex shank attachment 16, a tool head receiver, shown as a hex receiver attachment 18, and a tool head, shown as a drill head 20.

Flexible shaft 12 has a generally cylindrical shape. Flexible shaft 12 extends from first end 9 to second end 11. Collar 14 is slidably retained circumferentially around flexible shaft 12 and is configured to freely rotate with respect to flexible shaft 12 about an axis of flexible shaft 12. This rotation of collar 14 with respect to flexible shaft 12 allows users to grip and direct flexible shaft 12, hex receiver attachment 18, and drill head 20 while flexible drill bit assembly 10 is rotating in use. For example, a user can apply a force to collar 14 in a direction D1 while flexible drill bit assembly 10 is rotating that results in movement of drill head 20 in a direction D2. Similarly, a user can apply a bending moment to flexible shaft 12 by applying a bending force to collar 14 in direction D1 to bend flexible drill bit assembly 10 while rotating in use. The user thereby moves hex receiver attachment 18 in direction D2 to angle or position drill head 20 in a desired direction during use, as shown in FIG. 1B.

As shown in FIG. 1A, hex shank attachment 16 is coupled, such as detachably coupled, to first end 9 of flexible shaft 12, and hex receiver attachment 18 is coupled, such as detachably coupled, to second end 11 of flexible shaft 12. Hex shank attachment 16 and hex receiver attachment 18 retain collar 14 by not allowing collar 14 to move past either end of flexible shaft 12. Hex shank attachment 16 is configured to detachably couple flexible drill bit assembly 10 to a driving tool, such as a power drill 8, or to additional flexible shafts in series to provide an extended drill bit assembly. Hex receiver attachment 18 is configured to detachably couple flexible shaft 12 to a tool head, such as drill head 20, or to additional flexible shafts in series to provide an extended drill bit assembly. Hex shank attachment 16 and hex receiver attachment 18 are configured to releasably attach flexible drill bit assembly 10 to additional components without requiring additional fasteners. In various embodiments, flexible shaft 12 defines first diameter 13 and first length 15. In various embodiments, first diameter 13 is the maximum diameter of the flexible inner portion of flexible shaft, as in not the portions of flexible shaft 12 that couple to hex shank attachment 16 or hex receiver attachment 18.

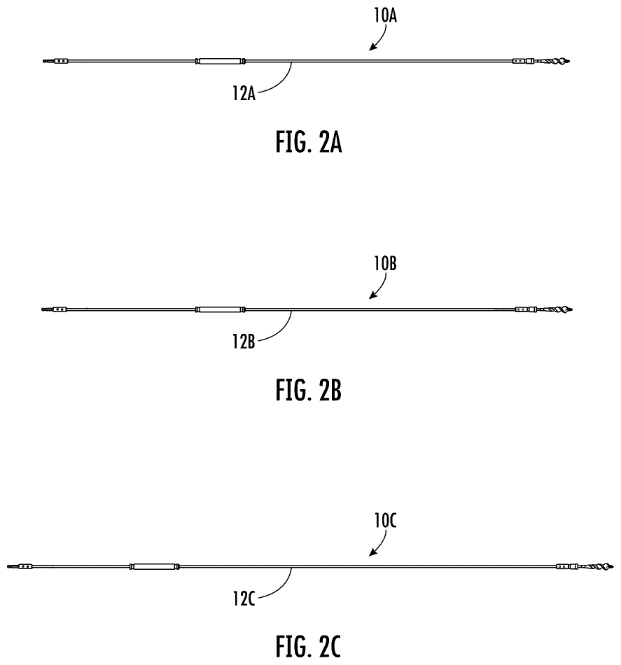

Referring to FIGS. 2A-2C, flexible drill bit assembly 10 may have a flexible shaft having a different diameter or length according to various embodiments. In various embodiments, flexible shaft 12 has a diameter that is between 0.1 and 0.5 inches and a length of between 40 and 100 inches. In specific embodiments, flexible shaft 12 has a diameter of about 3/16 of an inch or a diameter of about 0.25 inches and a length of about 54 inches or a length of about 72 inches. As shown in FIG. 2A, flexible shaft 12A has a diameter of about 3/16 of an inch and a length of about 54 inches. Alternatively, flexible shaft 12B has a diameter of about 0.25 inches and a length of about 54 inches, as shown in FIG. 2B. In other embodiments, flexible shaft 12C has a diameter of about 0.25 inches and a length of about 72 inches, as shown in FIG. 2C.

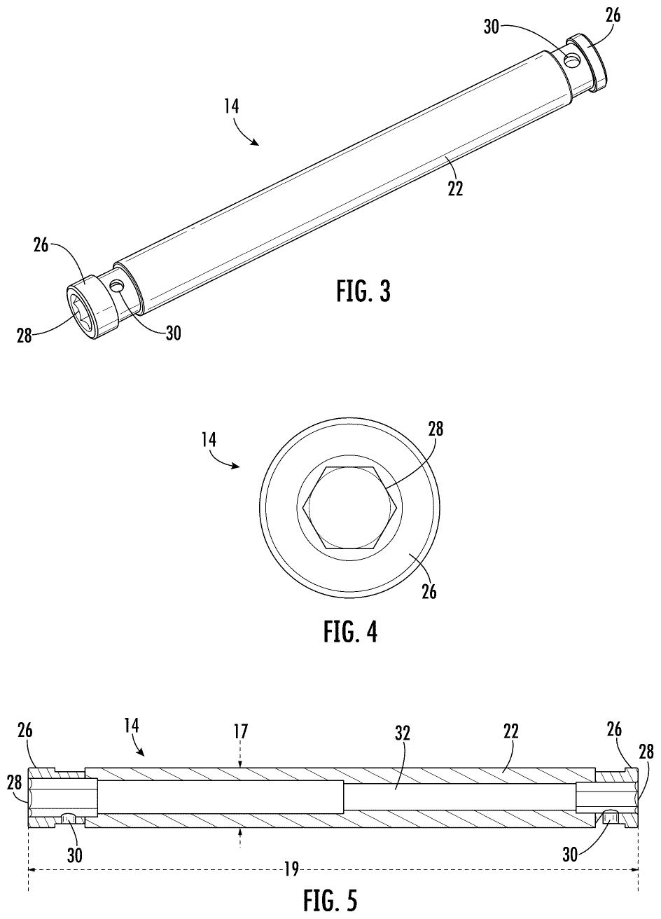

As shown in FIG. 3, collar 14 includes a sleeve 22 and tube ends 26 coupled to both ends of sleeve 22. Collar 14 defines interior channel 32 through which flexible shaft 12 extends. In various embodiments, collar 14 is more resistant to bending than flexible shaft 12. Sleeve 22 and/or tube ends 26 are made from a rigid material, such as steel, such that collar 14 is more rigid and is resistant to bending than flexible shaft 12. In a specific embodiment, collar 14 includes an outer shell formed by a plastic material and a rubber over mold. Tube ends 26 include openings 28 through which flexible shaft 12 extends. Tube ends 26 include side holes 30. Openings 28 have a hexagonal cross-section, shown in FIG. 4.

Referring to FIG. 5, openings 28 provide access to a generally cylindrical interior channel 32 that extends the full length through collar 14. Interior channel 32 allows flexible shaft 12 to pass through collar 14 such that collar 14 can slide axially along flexible shaft 12 and rotate with respect to flexible shaft 12. Side holes 30 are configured to assist in assembly of flexible drill bit assembly 10. In various embodiments, collar 14 is axially slidable along the flexible shaft 12, and collar 14 is rotatable with respect to the flexible shaft 12. In various embodiments, collar 14 freely rotates with respect to the flexible shaft 12 such that lateral forces (e.g., a force in direction D1) can be applied by a user to the flexible shaft 12 via the collar 14 while the flexible shaft is in use rotating (e.g., rotating the drill head 20).

In various embodiments, collar 14 defines second diameter 17 and second length 19. In various embodiments, second diameter 17 is more than 1.5 times first diameter 13. In various embodiments, second diameter 17 is less than 3.5 times first diameter 13. In various embodiments second diameter 17 of collar 14 is between 1.5 and 3.5 times the first diameter 13 of flexible shaft 12. Applicant has found that these proportions of the diameters of flexible shaft 12 and collar 14 allow users to easily feel when flexible drill bit assembly 10 contacts objects during use due to the relatively short distance between the user's hand and flexible shaft 12 when holding collar 14. In a specific embodiment, collar 14 has a length of at least 4 inches.

In various embodiments, second length 19 is less than ⅛ the first length 15. In various embodiments, second length 19 is more than 1/16 the first length 15. In various embodiments, second length 19 of collar 14 is between 1/16 and ⅛ the first length 15 of flexible shaft 12. Applicant has found that these proportions of the lengths of flexible shaft 12 and collar 14 allow users to effectively use collar 14 as a fulcrum when applying bending forces to flexible shaft 12 through collar 14.

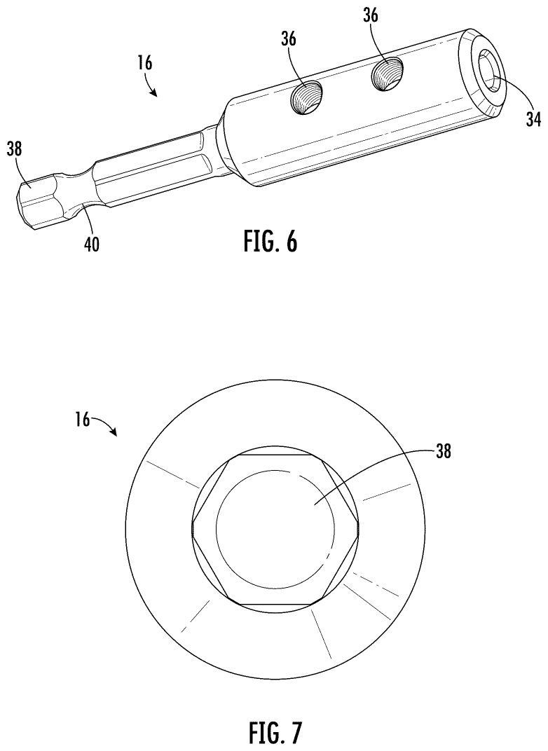

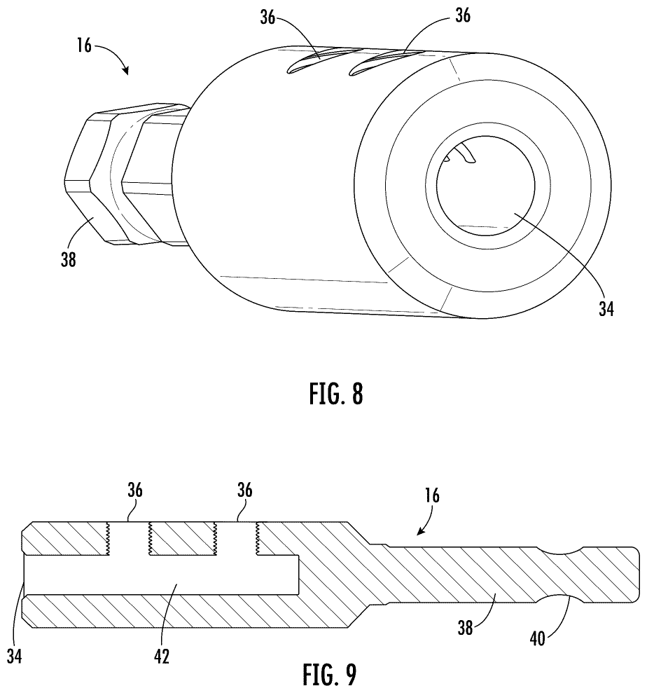

Referring to FIGS. 6-9, hex shank attachment 16 includes a receiver opening, shown as first shaft receiver opening 34, hex shank fastener holes 36, and an endpiece, shown as hex shank 38. Hex shank attachment 16 includes hex shank 38 and first shaft receiver opening 34 opposite hex shank 38. Hex shank 38 includes concave recess 40 between hex shank 38 and first shaft receiver opening 34. Hex shank attachment 16 includes a channel, shown as first shaft receiver channel 42, that extends away from first shaft receiver opening 34, and fastener hole 36 in fluid communication with the first shaft receiver opening 34 via first shaft receiver channel 42. Hex shank 38 includes concave recess 40 configured to releasably couple to a retaining ball within a hexagonally shaped receiver of a tool or additional flexible shaft. Hex shank 38 has a generally hexagonal cross-section, shown in FIG. 7. In various embodiments, first shaft receiver opening 34 defines a cylindrical opening. As shown in FIG. 8, first shaft receiver opening 34 is generally cylindrical and is configured to retain an end of flexible shaft 12. Referring to FIG. 9, hex shank fastener holes 36 are configured to allow appropriate fasteners, such as screws, bolts, etc., to pass through hex shank attachment 16 from an outer surface into a first shaft receiver channel 42. Such fasteners can apply a clamping force to flexible shaft 12 within first shaft receiver channel 42 to secure and rigidly couple an end of flexible shaft 12 to hex shank attachment 16.

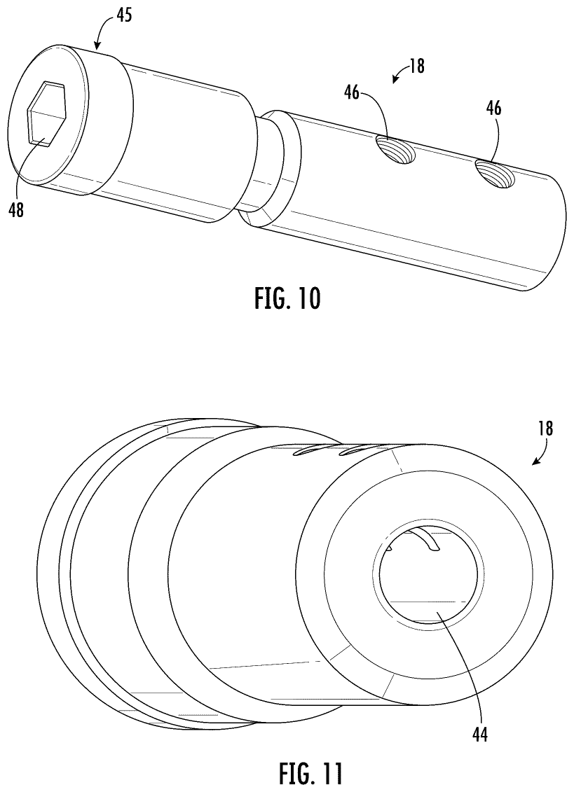

Referring to FIGS. 10-13, hex receiver attachment 18 is shown according to an exemplary embodiment. Hex receiver attachment 18 is substantially similar to hex shank attachment 16 except for the differences discussed herein. Hex receiver attachment 18 includes a second shaft receiver opening 44, hex receiver fastener holes 46, and a hex receiver opening 48. In various embodiments, hex receiver attachment 18 includes an endpiece 45 and a receiver opening, shown as second shaft receiver opening 44, opposite the endpiece 45, and the endpiece 45 defines hex receiver opening 48, which in various embodiments is a hexagonal cross-section opening. In various embodiments, hex receiver attachment 18 includes channel 52 that extends away from the second shaft receiver opening 44, and a fastener hole 46 in fluid communication with the second shaft receiver opening 44 via the channel 52.

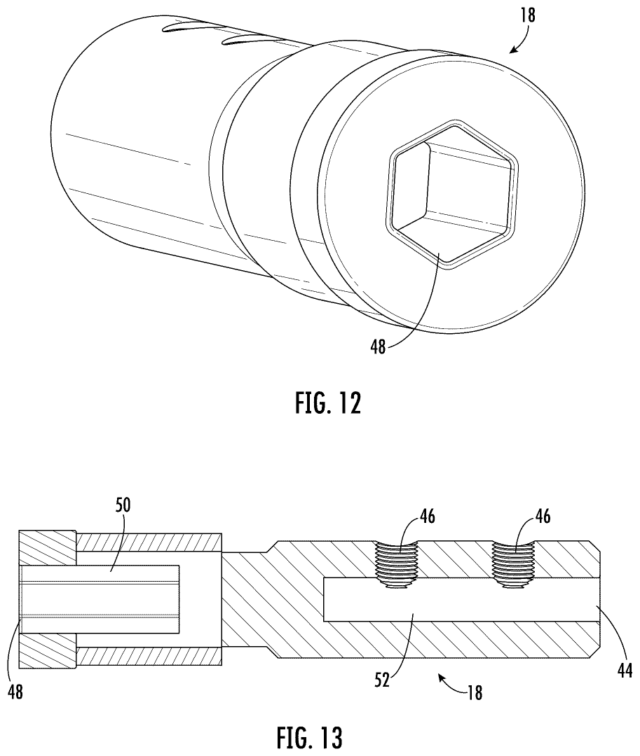

As shown in FIG. 11, second shaft receiver opening 44 is generally cylindrical. In various embodiments, second shaft receiver opening 44 defines a cylindrical opening. Hex receiver opening 48 has a generally hexagonal cross-section, shown in FIG. 12. Referring to FIG. 13, hex receiver opening 48 opens into hex channel 50. Hex channel 50 is configured to receive a hexagonally shaped shank, such as from a tool head or an additional flexible shaft. Hex receiver fastener holes 46 are configured to allow appropriate fasteners, such as screws, bolts, etc., to pass through hex receiver attachment 18 from an outer surface into a second shaft receiver channel 52. Such fasteners can apply a clamping force to flexible shaft 12 within second shaft receiver channel 52 to secure and rigidly couple an end of flexible shaft 12 to hex receiver attachment 18.

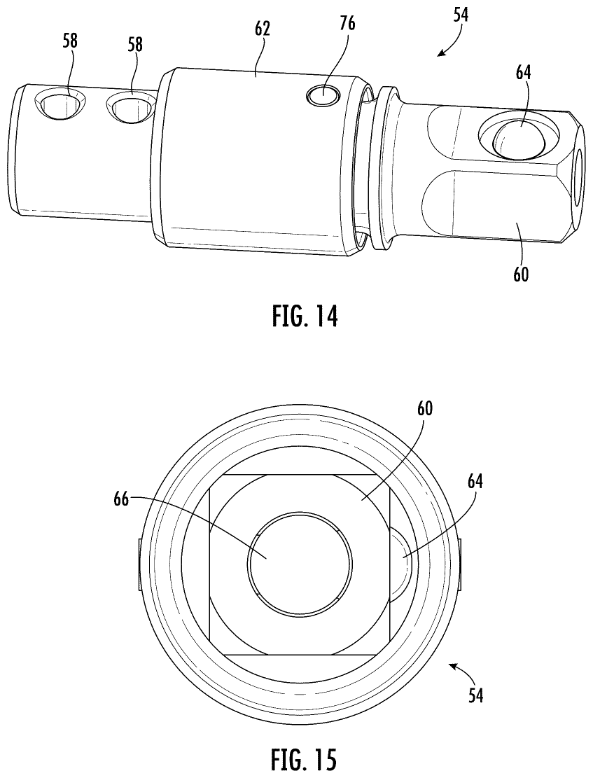

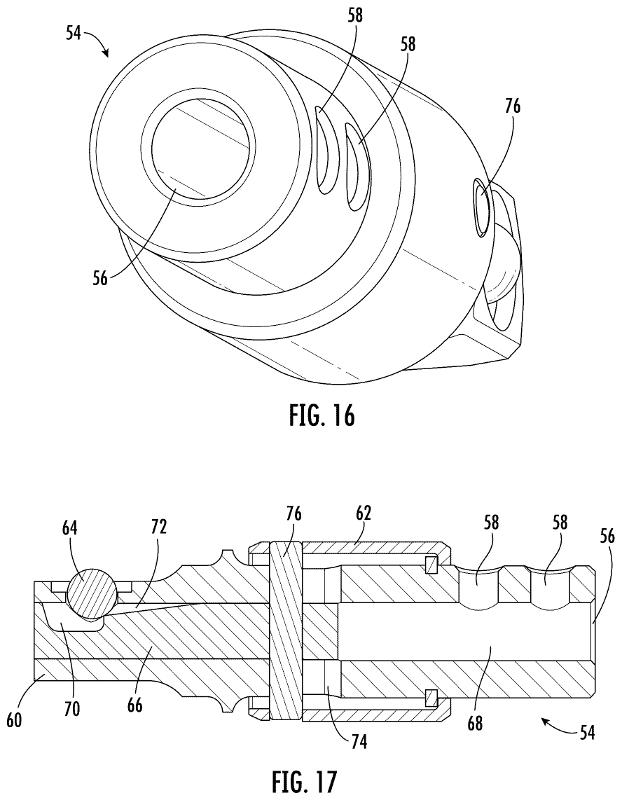

Referring to FIGS. 14-17, a square drive attachment 54 is shown according to an exemplary embodiment. Square drive attachment 54 is substantially similar to hex shank attachment 16 except for the differences discussed herein. Square drive attachment 54 includes a third shaft receiver opening 56, square drive fastener holes 58, a square shank 60, and a retention sleeve 62. As shown in FIG. 15, square shank 60 has a generally square cross-section and includes a retaining ball 64 and a generally cylindrical actuator shaft 66. In an alternative embodiment, square shank 60 is replaced with a hex shank having a generally hexagonal cross-section. Referring to FIG. 16, third shaft receiver opening 56 is generally cylindrical.

As shown in FIG. 17, third shaft receiver opening 56 opens into a third shaft receiver channel 68 that extends the entire length of square drive attachment 54. Actuator shaft 66 extends through a portion of third shaft receiver channel 68 and includes a recess 70, a slanted portion 72, and a coupling channel 74. Slanted portion 72 presses against retaining ball 64, causing retaining ball 64 to protrude beyond an outer surface of square drive attachment 54. Square drive attachment 54 further includes a coupling member 76 coupled to retention sleeve 62. Coupling member 76 passes through coupling channel 74 to rigidly couple retention sleeve 62 to actuator shaft 66.

Retention sleeve 62 is configured to slide along an outer surface of square drive attachment 54 in an axial direction with respect to the generally cylindrical third shaft receiver channel 68. Retention sleeve 62 is biased toward square shank 60. When retention sleeve 62 is moved away from square shank 60, recess 70 aligns with retaining ball 64, causing retaining ball 64 to recede substantially below the outer surface of square drive attachment 54. This allows users to securely connect square shank 60 to a driving tool or tool head such that retaining ball 64 extends into a cavity within the driving tool or tool head and detach square shank 60 from the driving tool or tool head by pulling back on retention sleeve 62 and disengaging retaining ball 64 from the driving tool or tool head. The secure attachment of square drive attachment 54 to a driving tool or tool head via retaining ball 64 prevents components of flexible drill bit assembly 10 from detaching when pulling flexible drill bit assembly out of a workspace, such as the inside of a wall or conduit.

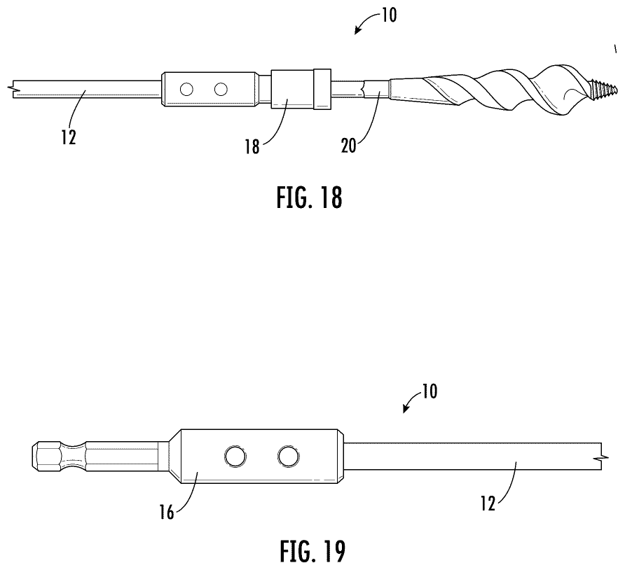

Referring to FIGS. 18 and 19, flexible drill bit assembly 10 includes hex shank attachment 16 and hex receiver attachment 18 coupled to ends of flexible shaft 12. In some embodiments of flexible drill bit assembly 10, at least one of hex shank attachment 16 and/or hex receiver attachment 18 are replaced with square drive attachment 54 such that square drive attachment 54 is coupled to an end of flexible shaft 12. Applicant has found that including one of hex shank attachment 16, hex receiver attachment 18, and/or square drive attachment 54 on each end of flexible drill bit assembly 10 provides for a variety of benefits, including easily pairing with other flexible drill bit shafts in series, quick and easy attachment and detachment from driving tools, such as drills, and quick and easy attach to various tool heads (augers, tile cutters, hooks, etc.) without requiring additional fasteners or individual extended flexible shafts for each tool head.

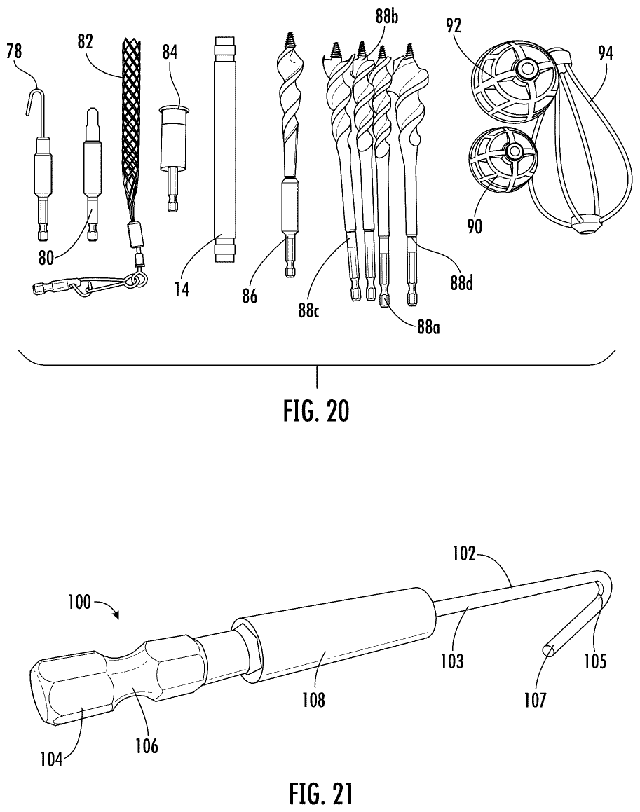

Referring to FIG. 20, flexible drill bit assembly 10 can be paired with a variety of tool heads and accessories to form a flexible drill bit kit, according to an exemplary embodiment. The flexible drill bit kit includes flexible drill bit assembly 10, a hook accessory 78, a through-hole bullet nose accessory 80, a finger trap wire accessory 82, a tile cutter 84, collar 14, a dirt auger 86, wood augers 88a-88d, a first alignment ball 90, a second alignment ball 92, and/or an alignment cage 94. Applicant has found that providing a flexible drill bit kit including flexible drill bit assembly 10 and a variety of tool heads and accessories allows users to easily interchange components of flexible drill bit assembly 10 for different applications, such as directing wires or cables through walls, drilling through wood, drilling through dirt, drilling within walls or floors, cutting tile, etc.

Each of hook accessory 78, through-hole bullet nose accessory 80, finger trap wire accessory 82, tile cutter 84, dirt auger 86, and wood augers 88a-88d include hex shanks configured to couple to hex receiver attachment 18 of flexible drill bit assembly 10 and replace drill head 20. Hook accessory 78, through-hole bullet nose accessory 80, and finger trap wire accessory 82 may be coupled to flexible drill bit assembly 10 to grip and direct wires and cables. Wood augers 88a-88d allow users to drill a variety of radii holes with flexible drill bit assembly 10, wood auger 88a having the shortest radius, followed by wood auger 88b, followed by wood auger 88c, with wood auger 88d having the greatest radius. First alignment ball 90, second alignment ball 92, and alignment cage 94 can each be attached around flexible shaft 12 to increase the radius of flexible drill bit assembly 10 around flexible shaft 12, thereby reducing the likelihood of flexible shaft 12 bending out of alignment with a user's desired drilling location, for example, by alignment ball 90, second alignment ball 92, or alignment cage 94 contacting surrounding walls.

Referring to FIG. 21, a hook accessory 100 is shown, according to an exemplary embodiment. Hook accessory 100 is substantially similar to hook accessory 78 except for the differences discussed herein. Hook accessory 100 includes a hook end 102, a shank 104, a concave portion 106, and a shaft 108. Hook end 102 includes an axial portion 103, a bend 105, and an angled tip 107. Shank 104 has a generally hexagonal cross-section. Concave portion 106 is configured to releasably couple to a retaining ball within a hexagonally shaped receiver of a tool. Shaft 108 is rotatably coupled to shank 104. Hook end 102 is located at the end of shaft 108 such that hook end 102 can rotate with respect to shank 104.

Hook end 102 is configured to grip and retain wires, cables, or cords around bend 105, for example, while pulling the wires, cables, or cords through conduits or within walls. Shank 104 and concave portion 106 are configured to quickly, securely, and releasably attach hook accessory 100 to a tool or tool attachment, such as flexible drill bit assembly 10. Shank 104 and concave portion 106 are configured to provide a sufficiently secure attachment of hook accessory 100 to a tool for pulling wires, cables, cords, etc., while also providing a quick and simple means of removing and replacing hook accessory 100. Further, hook end 102 is configured to rotate with respect to shank 104 so that hook end 102 can spin freely while pulling wires, cables, cords, etc., and avoid unnecessary twisting or damage to the wires, cables, cords, etc. In a specific embodiment, flexible drill bit assembly 10 includes hook accessory 100.

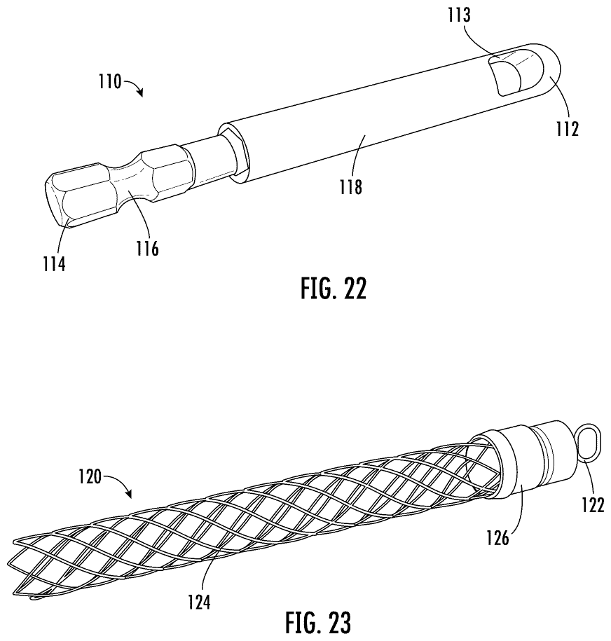

Referring to FIG. 22, a through-hole bullet nose accessory 110 is shown, according to an exemplary embodiment. Through-hole bullet nose accessory 110 is substantially similar to through-hole bullet nose accessory 80 except for the differences discussed herein. Through-hole bullet nose accessory 110 includes a through-hole end 112 having a through-hole 113, a shank 114, a concave portion 116, and a shaft 118. Shank 114 has a generally hexagonal cross-section. Concave portion 116 is configured to releasably couple to a retaining ball within a hexagonally shaped receiver of a tool. Shaft 118 is rotatably coupled to shank 114. Through-hole end 112 is located at the end of shaft 118 such that through-hole end 112 can rotate with respect to shank 114.

Through-hole end 112 is configured to receive and retain portions of wires, cables, or cords that pass through through-hole 113, for example, while pulling the wires, cables, or cords through conduits or within walls. Shank 114 and concave portion 116 are configured to quickly, securely, and releasably attach through-hole bullet nose accessory 110 to a tool or tool attachment, such as flexible drill bit assembly 10. Shank 114 and concave portion 116 are configured to provide a sufficiently secure attachment of through-hole bullet nose accessory 110 to a tool for pulling wires, cables, cords, etc., while also providing a quick and simple means of removing and replacing through-hole bullet nose accessory 110. In general, through-hole end 112 is configured to rotate with respect to shank 114 so that through-hole end 112 can spin freely while pulling wires, cables, cords, etc., and avoid unnecessary twisting or damage to the wires, cables, cords, etc. In a specific embodiment, flexible drill bit assembly 10 includes through-hole bullet nose accessory 110.

In one exemplary method of using through-hole bullet nose accessory 110 and/or through-hole bullet nose accessory 80, initially a user drills a hole through an object, such as one or more walls. The one or more holes are drilled through attaching a cutting tip, such as drill head 20, to a power drill, such as to flexible shaft 12 coupled to power drill 8. After the hole(s) are drilled, the user detaches drill head 20 from flexible shaft 12 while flexible shaft 12 is extending through the hole(s). The user then attaches a wire pulling object, such as through-hole bullet nose accessory 110, to the flexible shaft 12 while flexible shaft 12 is extending through the hole(s), couples one or more wires to through-hole bullet nose accessory 110, and subsequently pulls through-hole bullet nose accessory 110 and the wire(2) through the hole(s). In this way, the user can easily couple and decouple accessories to power drill 8 to facilitate pulling wire(s) through hole(s).

Referring to FIG. 23, a finger trap accessory 120 is shown according to an exemplary embodiment. Finger trap accessory 120 includes a ring attachment end 122, a finger trap end 124, and a finger trap receiver 126. Ring attachment end 122 is configured to couple finger trap accessory 120 to a tool or tool attachment, such as flexible drill bit assembly 10. Finger trap end 124 has a generally cylindrical shape formed from a flexible mesh of wires. Finger trap accessory 120 is configured to receive a wire or cable within finger trap end 124 such that the flexible mesh of finger trap end 124 stretches around and retains an end of the wire or cable, for example, while pulling the wire or cable through conduits or within walls.

As shown in FIG. 23, finger trap end 124 is coupled to an inner surface of finger trap receiver 126. Finger trap receiver 126 is rotatably coupled to ring attachment end 122. Finger trap end 124 is configured to spin freely with respect to ring attachment end 122 while pulling wires or cables to avoid unnecessary twisting or damage to the wires or cables. In a specific embodiment, flexible drill bit assembly 10 includes finger trap accessory 120.

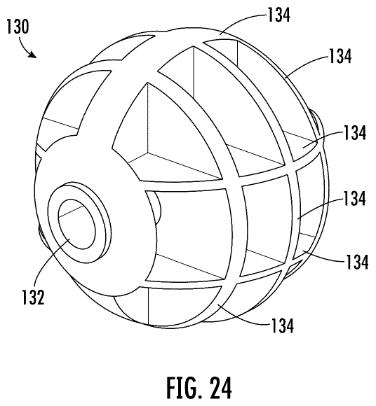

Referring to FIG. 24, an alignment ball 130 is shown, according to an exemplary embodiment. Alignment ball 130 includes a through-hole 132 and a plurality of radially extending walls 134. Alignment ball 130 is configured to allow flexible shaft 12 to extend through through-hole 132 such that alignment ball 130 is coupled to flexible drill bit assembly 10. When flexible shaft 12 extends through through-hole 132 such that a portion of flexible shaft 12 is located within alignment ball 130, radially extending walls 134 increase the radius of flexible drill bit assembly 10 around flexible shaft 12, thereby reducing the likelihood of flexible shaft 12 bending out of alignment with a user's desired drilling location, for example, by alignment ball 130 contacting surrounding walls. In a specific embodiment, flexible drill bit assembly 10 includes alignment ball 130.

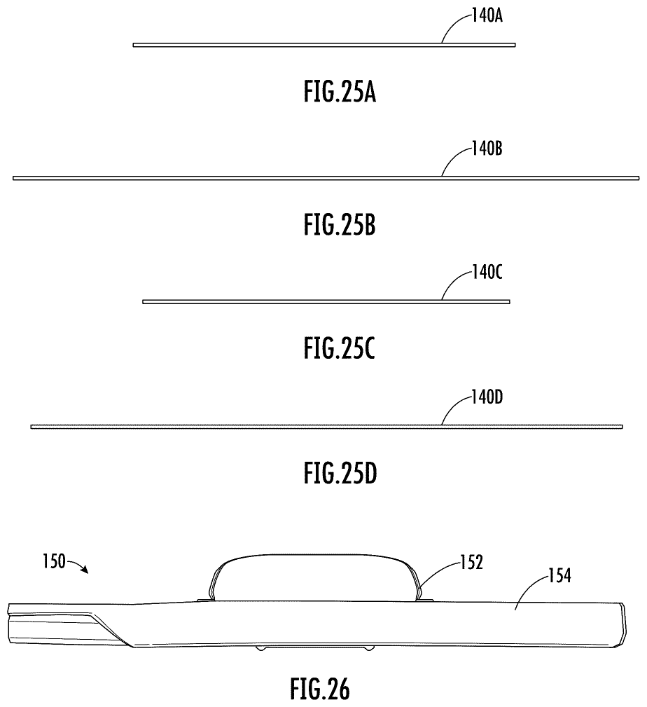

Referring to FIGS. 25A-25D, flexible drill bit assembly 10 may have a flexible shaft having different flexibilities or lengths, according to various embodiments. A flexible shaft 140A and a flexible shaft 140B are configured to be more flexible than a flexible shaft 140C and a flexible shaft 140D. Flexible shaft 140A has a durometer that is less than the durometer of flexible shaft 140C. Flexible shaft 140B has a durometer that is less than the durometer of flexible shaft 140D. In a specific embodiment, flexible shaft 140A and flexible shaft 140B each have a diameter of between 0.25 inches and 0.1 inches and specifically each have a diameter of about 3/16 inches. In a specific embodiment, flexible shaft 140C and flexible shaft 140D each have a diameter of between 0.375 inches and 0.125 inches and specifically each have a diameter of about 0.25 inches. Shafts that are more flexible, such as flexible shaft 140A and flexible shaft 140B, can more easily accommodate tight radius bends than stiffer shafts, such as flexible shaft 140C and flexible shaft 140D. Shafts that are stiffer, such as flexible shaft 140C and flexible shaft 140D, provide more stability than more flexible shafts, such as flexible shaft 140A and flexible shaft 140B, when applying forces through the shafts, for example, when drilling along long straight passageways.

Flexible shaft 140A and flexible shaft 140C each have a length of between 15 inches and 60 inches. In a specific embodiment, flexible shaft 140A and flexible shaft 140C each have a length of about 24 inches. Flexible shaft 140B and flexible shaft 140D each have a length of between 40 inches and 100 inches. In a specific embodiment, flexible shaft 140B and flexible shaft 140D each have a length of about 54 inches. In an alternative embodiment, flexible shaft 140A and flexible shaft 140C each have a length of about 54 inches, and flexible shaft 140B and flexible shaft 140D each have a length of about 72 inches.

Referring to FIG. 26, a carrying case 150 is shown, according to an exemplary embodiment. Carrying case 150 includes a handle 152 and a shell 154. Carrying case 150 is configured to store components of flexible drill bit assembly 10 or a kit including flexible drill bit assembly 10 within shell 154. In a specific embodiment, a flexible drill bit kit includes flexible drill bit assembly 10, flexible shaft 12A, flexible shaft 12B, flexible shaft 12C, flexible shaft 140A, flexible shaft 140B, flexible shaft 140C, flexible shaft 140D, collar 14, drill head 20, square drive attachment 54, hook accessory 100, through-hole bullet nose accessory 110, finger trap accessory 120, alignment ball 130, and/or carrying case 150. The flexible drill bit kit includes a plurality of flexible shafts having different lengths, diameters, and flexibilities to provide a variety of shafts suited for different use cases. Further, the flexible drill bit kit includes both tip accessories used for cutting, such as drill head 20, and tip accessories used for pulling, such as hook accessory 100, through-hole bullet nose accessory 110, and finger trap accessory 120, to provide a variety of accessory tips suited for different use cases.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. In addition, as used herein, the article “a” is intended to include one or more component or element and is not intended to be construed as meaning only one.

While the current application recites particular combinations of features in any claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A flexible drill bit assembly for a power drill comprising:
a flexible shaft extending from a first end to an opposing second end;
a driving tool engaging shank coupled to the first end of the flexible shaft, the driving tool engaging shank is configured to detachably couple to a power drill;
a tool head receiver coupled to the second end of the flexible shaft, the tool head receiver is configured to detachably couple to a tool head; and
a collar defining an interior channel through which the flexible shaft extends, wherein the collar is axially slidable along the flexible shaft, and wherein the collar is rotatable with respect to the flexible shaft.

2. The flexible drill bit assembly of claim 1, wherein the collar freely rotates with respect to the flexible shaft such that lateral forces can be applied by a user to the flexible shaft via the collar while the flexible shaft is in use rotating.

3. The flexible drill bit assembly of claim 1, wherein the flexible shaft defines a first diameter and the collar defines a second diameter, and wherein the second diameter is more than 1.5 times the first diameter.

4. The flexible drill bit assembly of claim 3, wherein the second diameter is less than 3.5 times the first diameter.

5. The flexible drill bit assembly of claim 1, wherein the flexible shaft defines a first diameter and the collar defines a second diameter, and wherein the second diameter is between 1.5 times and 3.5 times the first diameter.

6. The flexible drill bit assembly of claim 1, wherein the flexible shaft defines a first length and the collar defines a second length, and wherein the second length is less than ⅛ the first length.

7. The flexible drill bit assembly of claim 6, wherein the second length is more than 1/16 the first length.

8. The flexible drill bit assembly of claim 1, wherein the flexible shaft defines a first length and the collar defines a second length, and wherein the second length is between ⅛ and 1/16 the first length.

9. The flexible drill bit assembly of claim 8, wherein the flexible shaft defines a first diameter and the collar defines a second diameter, and wherein the second diameter is between 1.5 times and 3.5 times the first diameter.

10. The flexible drill bit assembly of claim 1, wherein the collar is more resistant to bending than the flexible shaft.

11. The flexible drill bit assembly of claim 1, the collar comprising a sleeve and tube ends coupled to both ends of the sleeve, each of the tube ends comprising an opening through which the flexible shaft extends.

12. A flexible drill bit assembly for a power drill comprising:
a flexible shaft extending from a first end to an opposing second end;
a driving tool engaging shank detachably coupled to the first end of the flexible shaft, the driving tool engaging shank is configured to detachably couple to a power drill; and
a tool head receiver coupled to the second end of the flexible shaft, the tool head receiver is configured to detachably couple to a tool head.

13. The flexible drill bit assembly of claim 12, the driving tool engaging shank comprising an endpiece and a receiver opening opposite the endpiece, the endpiece defining a hexagonal cross-section.

14. The flexible drill bit assembly of claim 13, the driving tool engaging shank comprising a concave recess between the endpiece and the receiver opening.

15. The flexible drill bit assembly of claim 13, wherein the receiver opening defines a cylindrical opening.

16. The flexible drill bit assembly of claim 13, the driving tool engaging shank comprising a channel that extends away from the receiver opening, and a fastener hole in fluid communication with the receiver opening via the channel.

17. A flexible drill bit assembly for a power drill comprising:
a flexible shaft extending from a first end to an opposing second end;
a driving tool engaging shank coupled to the first end of the flexible shaft, the driving tool engaging shank is configured to detachably couple to a power drill; and
a tool head receiver detachably coupled to the second end of the flexible shaft, the tool head receiver is configured to detachably couple to a tool head.

18. The flexible drill bit assembly of claim 17, the tool head receiver comprising an endpiece and a receiver opening opposite the endpiece, the endpiece defining a hexagonal cross-section opening.

19. The flexible drill bit assembly of claim 18, wherein the receiver opening defines a cylindrical opening.

20. The flexible drill bit assembly of claim 18, the tool head receiver comprising a channel that extends away from the receiver opening, and a fastener hole in fluid communication with the receiver opening via the channel.
